(19) United States
(12) Patent Application Publication
(10) Pub. No.: US 2026/0326466 A1
(43) Pub. Date: Oct. 22, 2026

(54) MOVABLE ELECTRONIC COMPONENTS

(71) Applicant: HEWLETT-PACKARD DEVELOPMENT COMPANY, L.P., Spring, TX (US)

(72) Inventors: Borja NAVAS SANCHEZ, Sant Cugat del Valles (ES); Isidoro MAYA AGUDO, Sant Cugat del Valles (ES); Francisco Javier ALFARO REYES, Sant Cugat del Valles (ES); Arnau JANER I SERRAMIA, Sant Cugat del Valles (ES)

(73) Assignee: HEWLETT-PACKARD DEVELOPMENT COMPANY, L.P., Spring, TX (US)

(21) Appl. No.: 19/486,817

(22) PCT Filed: Jun. 9, 2023
(86) PCT No.: PCT/US2023/068207

§ 371 Date: Nov. 21, 2025

(51) Int. Cl. B41J 29/387; B41J 3/28; B41J 29/393; G05D 1/49; G05D 105/00; G05D 109/10

(52) U.S. Cl. CPC B41J 29/387; B41J 3/28; B41J 29/393; G05D 1/498; G05D 2105/17; G05D 2109/10

(57) ABSTRACT

According to an example, a surface marking robot comprises a set of front wheels, a set of rear wheels, an electronic component, and a weight distribution system. The weight distribution system comprises an actuator to move the electronic component along a longitudinal axis of the robot, and a controller operatively connected to the actuator. The controller is configured to control the actuator to move the electronic component from a first position to a second position with respect to the set of front wheels in response to an emergency stop signal.

### BACKGROUND

Surface marking robots may be used to draw or print lines or patterns on a surface. In some examples, surface marking robots may include a pen or a printhead to apply a printing fluid on a surface in accordance with a plot or an image to be printed. In some examples, surface marking robots may print on sloped surfaces.

### BRIEF DESCRIPTION OF DRAWINGS

Features of the present disclosure are illustrated by way of example and are not limited in the following figure(s), in which like numerals indicate like elements, in which:

FIG. 1 shows a surface marking robot comprising a movable electronic component and a weight distribution system, according to an example of the present disclosure;

FIG. 2 shows a surface marking robot including an actuator to move an electronic component from a first position to a second position, according to an example;

FIG. 3 shows a surface marking robot in which multiple positions of an electronic component with respect to a set of front wheels of the printing system are represented, according to an example;

FIG. 4 shows an emergency stop method for a surface marking robot, according to an example; and

FIG. 5 shows a side view of a surface marking robot moving over a sloped surface, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Surface marking robots may print onto a wide variety of surfaces. Surface marking robots dispense droplets of printing fluid as the surface marking robots move over a surface. The surface marking robot, which is movable relative to the surface, may include an advance mechanism to generate traction on a component of the surface marking robot which is in contact with the surface (e.g., a plurality of wheels or closed belts). In some examples, the advance mechanism may be mechanically connected to a plurality of wheels such that a force generated by the advance mechanism is transmitted to the wheels such that the surface marking robot moves relative to the surface. In an example, the advance mechanism may be in the form of a drive motor, such as an electric motor.

During operation (e.g., while moving across a surface or while printing on the surface) surface marking robots may have to perform emergency stops. These emergency stops may be triggered by emergency stop signals received by a controller of a surface marking robot. In an example, the emergency stop signal may be associated with an excessive temperature in a component of the robot, a determination of an abnormal state for a component of the robot, or a lack of electrical power in the robot, among others. In other examples, the emergency stop signal may be issued by users at their discretion (for instance, by transmitting the emergency stop signal to a receiver operatively connected to the controller of the robot).

Surface robot marking robots change from an operative mode to a non-operative mode in response to an emergency stop. As used herein, the term “operative mode” refers to a mode of the robot in which the functionalities of the robot are not limited or constrained. As used herein, the term “non-operative mode” refers to a mode in which at least some of the functionalities of the robot are limited and/or the robot is set with a predefined configuration (for instance, the robot is controlled to be stationary such that the robot does not move over the surface). In an example, in the non-operative mode, at least some of the components of the robot do not receive electrical power from a power source of the surface marking robot. In some examples, all the components may be subjected to a cut-off state of power. Eventually, the cut-off state may cause the robot to become stationary, as explained above.

Emergency stops may damage the surface marking robot itself or external elements. In particular, when being in the non-operative mode, a speed of the surface marking robot may cause the surface marking robot to become unstable. For instance, in examples in which in the non-operative mode the advance mechanism of the surface marking robot is deactivated, the surface marking robot may accelerate in the non-operative mode while moving down a sloped surface, thereby compromising the integrity of the robot itself and/or elements located nearby. The speed of the surface marking robot reached while being in a non-operative mode may depend on the speed of the surface marking robot prior to the emergency stop and a surface profile associated with the surface where the robot is disposed on. Examples of characteristics include a friction coefficient of the surface, a slope of the surface, and a roughness level of the surface.

In some examples, a surface marking robot may roll over or overturn upon exceeding a threshold speed. The threshold speed may vary based on the characteristics of the surface where the robot is disposed. In an example, a threshold speed at which the marking robot is to roll over or overturn may be different when moving across a slanted surface than when moving across a substantially flat surface. In some examples, surface marking robots may exceed the threshold speed while the robot may move down a sloped surface while being in the non-operative mode.

Disclosed herein are examples of surface marking robots and emergency stop methods that may be used to reduce or avoid damage on surface marking robots and/or external components due to emergency stops. Hence, different examples of robots and methods are described.

According to an example, damage on the surface marking robot and/or external components resulting from emergency stops may be reduced by enhancing the stability of the surface marking robot in the non-operative mode. In some examples, surface marking robots may be designed with a small form factor and the location of some of the electronic components may render the surface marking robot unstable under some conditions. In an example, a surface marking robot may overturn or roll over upon exceeding a maximum allowable speed. As used herein, the wording “maximum allowable speed” refers to a maximum speed beyond which a surface marking robot is to roll over or overturn.

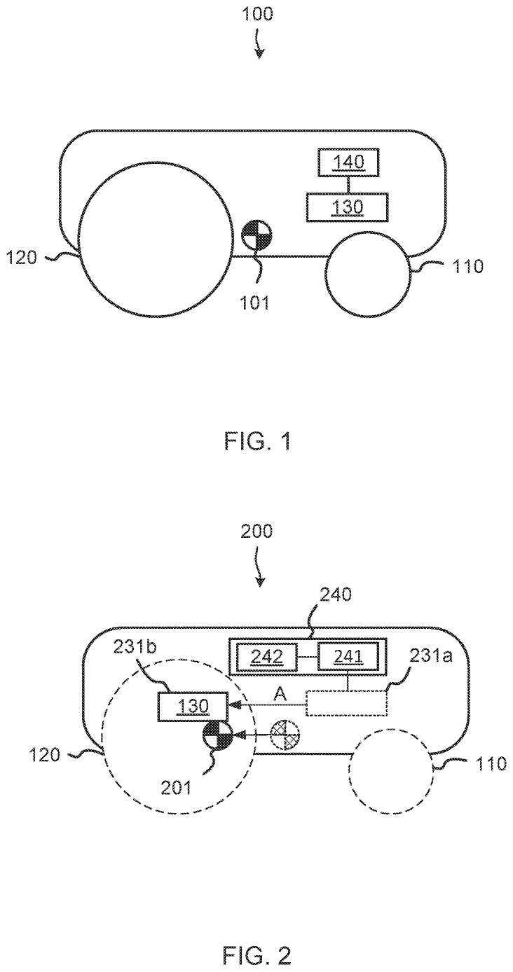

Referring now to FIG. 1, a surface marking robot 100 comprising a set of front wheels 110 and a set of rear wheels 120 is shown. The set of front wheels 110 and/or the set of rear wheels 120 may comprise at least one drive wheel. In an example, the wheels may be of a different type. Examples of wheels comprise caster wheels, drive wheels, idle wheels, belt-based wheels, and the like. The surface marking robot 100 may include a printhead (not shown in FIG. 1) to dispense printing fluid droplets on a surface where the surface marking robot 100 is disposed on. As used herein, the word “printhead” refers generally to a mechanism for the ejection of printing liquid. Examples of printheads are drop-on-demand printheads, such as piezoelectric printheads, thermo resistive printheads, or valve-based printheads. The surface marking robot 100 may be used to perform a printing operation in which the surface marking robot 100 dispenses printing fluid on the surface in accordance with a pattern as the surface marking robot 100 moves over the surface. As used herein, “printing fluid” refers generally to any substance that can be applied upon a surface by a printhead during operation, including but not limited to inks, primers and overcoat materials (such as a varnish), water, and solvents other than water.

In the example of FIG. 1, the surface marking robot 100 is represented with a center of gravity 101 illustrating an average location of the weight of an object. In particular, the center of gravity 101 in FIG. 1 is located in between the set of front wheels 110 and the set of rear wheels 120. Based on the location of the center of gravity with respect to the set of front wheels 110 and the set of rear wheels 120, a maximum allowable speed for the surface marking robot 100 may be defined.

The surface marking robot 100 further comprises an electronic component 130 and a weight distribution system 140. The weight distribution system 140 is mechanically connected to the electronic component 130 such that upon receiving an emergency stop signal, the weight distribution system 140 adjusts a location of the electronic component 130 with respect to the wheels such that the maximum allowable speed for the surface marking robot 100 is increased. As a result of the change of location of the electronic component 130, the center of gravity 101 of the surface marking robot 100 may vary. Accordingly, the adjustment of the location of the center of gravity 101 may increase the maximum allowable speed, thereby causing the stability of the surface marking robot to increase while being in the non-operative mode. As a result, during the non-operative mode, damage on the surface marking robot 100 and/or external elements located nearby is reduced or avoided.

As used herein, the term “electronic components” refers to a set of components comprising at least one of a printhead, a printing fluid supply, a printing fluid pump, a battery, a sensor module, wiring, a circuit board, and a drive motor. In some examples, the electronic components may be mechanically connected to the actuator via a rod, a rail, a frame, or a similar support structure that allows the electronic component to be moved by the actuator.

In some examples, adjusting the location of the electronic component 130 of the surface marking robot 100 may involve moving the electronic component from a first position to a second position. In an example, the movement towards the second position includes a horizontal component. In some examples, the weight distribution system 140 may adjust the location of the electronic component 130 such that the surface marking robot 100 has enhanced stability in the non-operative mode, thereby reducing the negative impacts of an acceleration of the robot due to the surface profile while the robot is in the non-operative mode.

Referring now to FIG. 2, a surface marking robot 200 comprising a weight distribution system 240 including an actuator 241 and a controller 242 is shown. The surface marking robot 200 further comprises a set of front wheels 110, a set of rear wheels 120, and an electronic component 130. In FIG. 2, elements previously explained in reference to the surface marking robot 100 of FIG. 1 have been numbered using the same reference numerals. To ease the explanation of the example, the set of front wheels 110 and the set of rear wheels 120 have been represented using a dash-dotted line.

The actuator 241 of the weight distribution system 240 is mechanically connected to the electronic component 130 and the controller 242 is operatively connected to the actuator 241. The actuator 241 is to move the electronic component 130 along a longitudinal axis of the robot 200. In particular, the actuator 241 is to move the electronic component from a first position 231a to a second position 231b with respect to the set of front wheels 110. The movement from the first position 231a to the second position 231b is represented by arrow A, which is parallel to the longitudinal axis of the surface marking robot 200. In FIG. 2, the electronic component is in the second position 231b, and the first position is represented using a dashed line.

Similar to the examples previously explained in reference to FIG. 1, adjusting a position of the electronic component 130 with respect to the wheels of the surface marking robot 200 may enhance the stability of the surface marking robot 200 when the robot 200 is in a non-operative mode. In the example of FIG. 2, the controller 242 of the weight distribution system 240 is configured to control the actuator 241 to move the electronic component 130 from the first position 231a (represented in dashed lines) to the second position 231b with respect to the set of front wheels 110 in response to an emergency stop signal. Accordingly, the movement of the electronic component 130 along the longitudinal axis of the robot 200 results in a change of a center of gravity 201 of the surface marking robot 200. For illustrative purposes, the center of gravity when the electronic component 130 is in the first position 231a is represented in a dashed line in FIG. 2.

In some examples, the actuator 241 may be a spring-loaded actuator 241. Spring-loaded actuators may allow for moving the electronic component 130 to the second position 231b even when the emergency stop results in a cut-off of the power in the surface marking robot 200. However, in other examples, alternative types of actuators may be possible, such as pneumatic actuators, solenoid actuators, or electric motors.

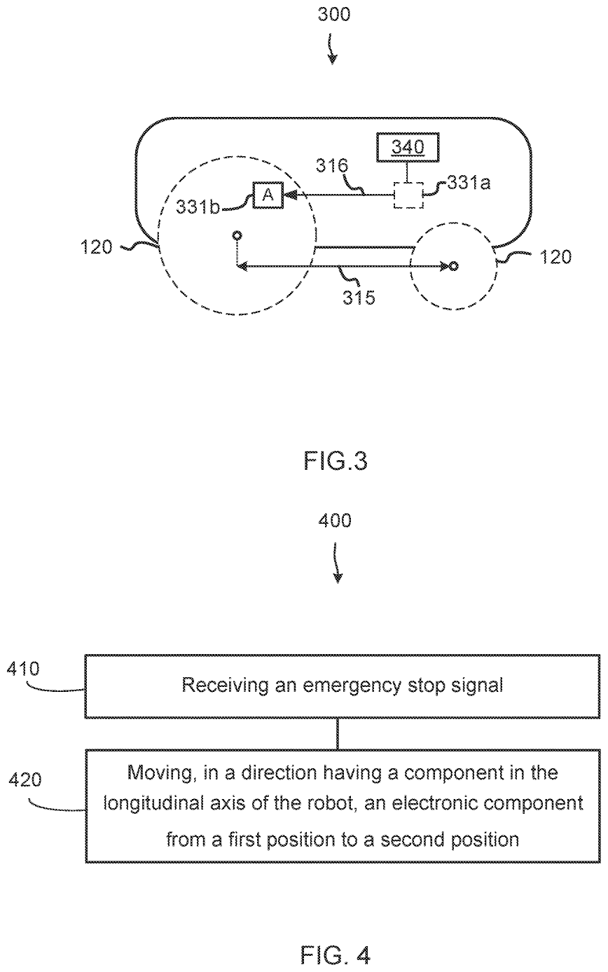

Referring now to FIG. 3, a surface marking robot 300 including an electronic component A in a second position 331b is shown. For illustrative purposes, a first position 331a of the electronic component A has been represented in a dashed line. The surface marking robot 300 further comprises a weight distribution system 340, which may correspond to any of the weight distribution systems 140 and 240 previously explained in reference to FIGS. 1 and 2.

By adjusting a position of the electronic component A with respect to the wheels of the surface marking robot 300, the stability of the surface marking robot 300 may be enhanced. For instance, upon receipt of an emergency stop signal, the weight distribution system 340 may cause the electronic component A to move to a second position associated with improved stability. In the example of FIG. 3, a set of front wheels 110 and a set of rear wheels 120 of the surface marking robot 300 are spaced apart by a distance 315 and a travel distance 316 for the electronic component A from the first position 331a to the second position 331b are represented. In some examples, the travel distance 316 is less than the distance 315. In some other examples, the travel distance 316 may be set such that a center of gravity (not represented in FIG. 3) resulting from the movement of the electronic component A is closer to the set of rear wheels 120 in the second position 331b than in the first position 331a. In some examples, the electronic component A is closer to the set of front wheels 120 in the first position than in the second position 331b.

In some examples, the travel distance 316 from the first position 331a to the second position 331b may be set such that a range of movement of the electronic component A does not greatly reduce the space available in the surface marking robot 300. In an example, the travel distance 316 may be a distance within a range from 15 mm to 60 mm, such as a range from 20 mm to 40 mm, or a travel distance of 45 mm. In an example, the electronic component A may weigh about 800 grams and the overall weight of the surface marking robot 300 may be about 12 kilograms. In other examples, the electronic component may represent 10% of the overall weight of the surface marking robot 300. However, in some other examples, alternatives weights for the electronic component A and the robot 300 may be possible, such as a weight within a range from 500 grams to 3 kilograms for the electronic component A and a weight within a range from 7 kilograms to 12 kilograms for the surface marking robot 300.

According to some examples, a surface marking robot (e.g., surface marking robot 100, 200, and 300) may be provided a sensor module including sensors to determine a position of the electronic component with respect to the set of front wheels (e.g., wheels 110). The sensor (or sensor) of the sensor module may be part of the movable electronic component or may be arranged in a different location of the surface marking robot (e.g., a housing of the surface marking robot). In an example, the controller issues a signal associated with a non-operative mode of the surface marking robot upon the electronic component being away from the first position. In other examples, when disabling the power in the non-operative mode, the sensor may be provided in the form of a mechanical sensor, and the non-operative mode may be represented using a physical element on an external surface of the surface marking robot. In an example, the physical element may be in the form of a display showing a first color (e.g., green) while the surface marking robot is in the operative mode and a second color (e.g., red) when the surface marking robot is in the non-operative mode.

In some other examples, a controller operatively connected to a sensor of the surface marking robot may issue a subsequent signal associated with an operative mode of the surface marking robot upon the electronic component reaching the first position with the surface marking robot in the non-operative mode. Following the example of the physical sensor, the physical element may change from the second color (e.g., red) to the first color (green) upon the electronic component reaching the first position. As explained above, in the operative mode, the functionalities of the surface marking robot are not limited or constrained.

In other examples, some of the components of the surface marking robot may not be affected by a cut-off of the power. Accordingly, in an example, the controller of the surface marking robot is configured to control the actuator to move the electronic component to the first position in response to a reload signal. In an example, the reload signal may be issued to the controller upon pressing a button on the surface marking robot or upon issuing the signal via a remote device (e.g., a smartphone, a remote controller, or a computer).

According to an example, the surface marking robots 100, 200, 300 and examples thereof previously explained in reference to FIGS. 1 to 3 may be used in an emergency stop method. In an example, an emergency stop may be triggered by an emergency stop signal, which may be issued by the robot itself or by an external element (e.g., a smartphone, a remote controller, or a computer) operatively connected to a controller of the surface marking robot.

Referring now to FIG. 4, an emergency stop method 400 is shown. The emergency stop method 400 may be implemented by a surface marking robot comprising a set of front wheels, such as the surface marking robots previously explained in reference to FIGS. 1 to 3. As a result of the emergency stop method 400, the surface marking robot is provided with enhanced stability while being in a non-operative mode in which at least some of the functionalities of the robot are limited.

At block 410, method 400 comprises receiving an emergency stop signal. In an example, the signal may be received by a controller, such as the controller 242 in FIG. 2. The emergency stop signal may be indicative of an abnormal operation in at least one component of the surface marking robot or may be issued by an external device, as previously explained.

At block 420, method 400 comprises moving, in a direction having a component in a longitudinal axis of the robot, an electronic component of the surface marking robot from a first position to a second position with respect to the set of front wheels. Upon the electronic component being away from the first position, the surface marking robot is provided with enhanced stability as a result of a change in the location of the center of gravity in the surface marking robot. In an example, the second location may be selected such that the surface marking robot is more stable when at least some of its functionalities are limited. In an example, a movement downhill of the surface marking robot in the non-operative mode may cause the robot to accelerate as a result of the gravity force exerted thereon. In an example, block 420 may comprise moving the electronic component toward the second set of wheels. In other words, the second position may be closer to the set of rear wheels than the first position.

In some examples, prior to block 420, method 400 may further comprise disabling at least some of the functions of the surface marking robot. In an example, the functions may be related to the operation of the electronic components. As explained above, examples of electronic components comprise a printhead, a printing fluid supply, a printing fluid pump, a battery, a sensor module, wiring, a circuit board, and a drive motor. In some other examples, disabling at least some of the functions may comprise disabling the power of the electronic components. In an example, the disabling may at least overlap to block 420 of method 400. In other words, while disabling the capabilities the actuator may cause the electronic component to start moving toward the second position.

In other examples, method 400 may further comprise moving the electronic component back to the first position in response to a reload signal. Upon the electronic component is back at the first position, the surface marking robot is back in the operative mode and the functionalities that were limited during the non-operative mode are enabled back.

In some other examples, the emergency stop signal received at block 410 may be associated with a surface profile. As used herein, the term “surface profile” refers to data related to a surface on which the surface marking robot is disposed, the data including at least one of a slope level of the surface, a coefficient of friction, and a roughness level. In some examples, the second position for the electronic component may be determined based on the surface profile. Accordingly, when having the surface marking robot on a surface with, for instance, a greater slope, the second position may be selected such that a movement of the electronic component has a component in the longitudinal axis of the robot and a component in a vertical axis perpendicular to the longitudinal axis of the robot. As a result, the stability of the surface marking robot may be further enhanced compared to a movement along a longitudinal axis of the robot. In an example, the second position may be determined such that surface profiles associated with a greater slope result in a movement of the electronic component having a greater component in a vertical axis.

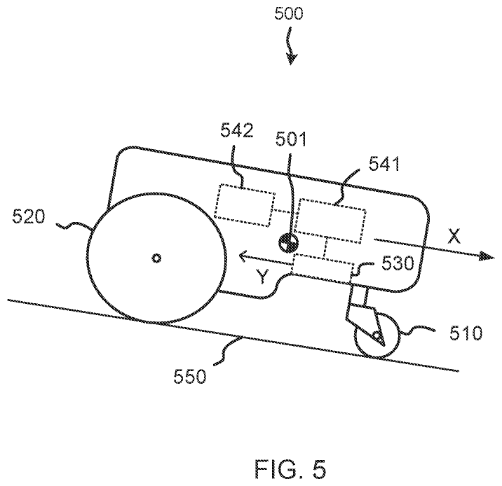

Referring now to FIG. 5, a side view of a surface marking robot 500 moving over a sloped surface 550 is shown. In particular, the surface marking robot 500 is moving down the sloped surface 550 in a direction indicated by arrow X. The surface marking robot 500 comprises a set of front wheels 510 and a set of rear wheels 520. Furthermore, elements of the surface marking robot 500 which not visible are represented in dashed lines, namely an electronic component 530 and a weight distribution system comprising an actuator 541 mechanically connected to the electronic component 530 and a controller 542 operatively connected to the actuator 541.

The actuator 541, which may correspond to the examples previously described in reference to FIGS. 1 to 4, is to move the electronic component 530 along a longitudinal axis of the robot 500. In FIG. 5, the longitudinal axis of the robot 500 is parallel to the direction indicated by arrow X.

As previously explained, surface marking robots may become unstable when reaching speeds beyond the maximum allowable speed. In an example, the maximum allowable speed in the operative mode of the surface marking robot 500 may be a speed greater than 0.6 m/s (for instance, 0.8 m/s or 1.2 m/s). Accordingly, controller 542 of the robot 500 is configured to control the actuator 541 to adjust a position of the electronic component with respect to the set of front wheels 510 and the set of rear wheels 520 in response to an emergency stop signal. The adjustment of the position may allow the surface marking robot to increase its maximum allowable speed, thereby rendering the surface marking robot more stable during a non-operative state in which at least some of the functionalities of the robot 500 are limited.

In the example of FIG. 5, the surface marking robot 500 has a center of gravity 501 located in between the set of front wheels 510 and the set of rear wheels 520. Upon receiving the emergency stop signal, at least some of the functionalities of the robot 500 may be limited, such as the braking system. As a result, the robot 500 may be unable to actively reduce its speed. Also, due to the slope of the sloped surface 550, the robot may even accelerate. However, as explained herein, the use of the weight distribution system including the actuator 541 and the controller 542 allows for improving the stability of the surface marking robot 500. In particular, the actuator 541 may move the electronic component in the direction indicated by arrow Y so as to increase the maximum allowable speed beyond which the surface marking robot may overturn or rollover.

In some examples, a maximum allowable speed in the non-operative mode of the surface marking robot 500 may be a speed greater than 0.6 m/s (such as 0.8 m/s, 1.2 m/s, 1.5 m/s, 2 m/s, or 5 m/s).

In some examples, the surface marking robot 500 may be used in the emergency stop methods previously explained in reference to FIG. 4.

Although in the examples explained in reference to FIGS. 1 to 3 and 5 the movement of the electronic component has been represented along a direction parallel to the longitudinal axis of the robot, in some other examples, the second location of the electronic component may be at a different height compared to the first location. As a result, when the surface marking robot is moving down a sloped surface in the non-operative mode, the maximum allowable speed obtained by a second location at a different height than the first location may be greater than when having the first and second locations at the same height (in other words, the movement from the first location to the second location does not include a vertical component). However, for illustrative purposes, all the examples explained in reference to FIGS. 1 to 3 and 5 have been represented along a direction parallel to the longitudinal axis of the robot.

Also, while the examples of FIGS. 1 to 3 and 5 have been explained in reference to surface marking robots 100, 200, 300, and 500 having a set of front wheels with a lower diameter than a set of rear wheels, it should be noted that alternative configurations may be possible. In an example, the surface marking robot may comprise additional wheels and the location of some of the features explained in reference to the robots may be different.

Nonetheless, alternative configurations should be defined such that a movement of the electronic component provides the robot with enhanced stability in the non-operative mode compared to the operative mode. In other words, the maximum allowable speed is higher in the non-operative mode than in the operative mode.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A surface marking robot comprising:
a set of front wheels;
a set of rear wheels;
an electronic component; and
a weight distribution system comprising:
an actuator to move the electronic component along a longitudinal axis of the robot; and
a controller operatively connected to the actuator, wherein the controller is configured to control the actuator to move the electronic component from a first position to a second position with respect to the set of front wheels in response to an emergency stop signal.

2. The robot of claim 1, wherein the set of front wheels comprises two drive wheels and the set of rear wheels comprises a caster wheel.

3. The robot of claim 1, wherein the actuator is a spring-loaded actuator.

4. The robot of claim 1, wherein the set of front wheels and the set of rear wheels are spaced apart by a distance, wherein a travel distance from the first position to the second position is less than the distance.

5. The robot of claim 4, wherein in the first position, the electronic component is closer to the set of front wheels in the first position than in the second position.

6. The robot of claim 4, wherein the travel distance is from 15 mm to 60 mm.

7. The robot of claim 1, wherein the electronic component comprises at least one of a printhead, a printing fluid supply, a printing fluid pump, a battery, a sensor module, wiring, a circuit board and a drive motor.

8. The robot of claim 1, further comprising a sensor to determine a position of the electronic component with respect to the set of front wheels, wherein the controller is to issue a signal associated with a non-operative mode of the surface marking robot upon the electronic component is away from the first position.

9. The robot of claim 8, wherein the sensor is to issue a subsequent signal associated with an operative mode of the electronic component upon the electronic component reaches the first position with the surface marking robot in the non-operative mode.

10. The robot of claim 8, wherein the controller is further configured to control the actuator to move the electronic component to the first position in response of a reload signal.

11. An emergency stop method for a surface marking robot comprising a set of front wheels spaced apart from a set of rear wheels, the method comprising:
receiving an emergency stop signal; and
moving, in a direction having a component in a longitudinal axis of the robot, an electronic component of the surface marking robot from a first position to a second position with respect to the set of front wheels.

12. The emergency stop method of claim 11, wherein moving the electronic component of the surface marking robot comprises moving the electronic component towards the set of rear wheels.

13. The emergency stop method of claim 11, further comprising:
moving the electronic component back to the first position in response to a reload signal.

14. The emergency stop method of claim 11, wherein the emergency stop signal is associated with a surface profile, the method further comprising: determining the second distance based on the surface profile.

15. A surface marking robot comprising:
a set of front wheels;
a set of rear wheels;
an electronic component;
a weight distribution system comprising:
an actuator to move the electronic component along a longitudinal axis of the robot; and
a controller operatively connected to the actuator, wherein the controller is to control the actuator to adjust a position of the electronic component with respect to the set of front wheels and the set of rear wheels in response to an emergency stop signal.
